(19) United States
(12) Patent Application Publication
(10) Pub. No.: US 2009/0315464 A1
(43) Pub. Date: Dec. 24, 2009

(54) TRANSFORMER AND BACKLIGHT APPARATUS

(75) Inventors: Ming Yen Wu, Taoyuan County (TW); Ching Chang Hsieh, Taoyuan County (TW); Ming-Chang Ho, Taoyuan County (TW); Pin Hsuan Chang, Kaohsiung County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp., Taoyuan (TW)

(21) Appl. No.: 12/416,585

(22) Filed: Apr. 1, 2009

(30) Foreign Application Priority Data
Jun. 24, 2008 (TW) 097211162

(51) Int. Cl. H05B 41/24; H01F 27/28

(52) U.S. Cl. 315/121; 315/276; 336/220

(57) ABSTRACT

The invention discloses a transformer for a backlight apparatus including a lamp and a detecting unit. The transformer includes a bobbin, a first winding and a second winding. The bobbin has a low-voltage winding region and a high-voltage winding region. The first winding is wound on the high-voltage winding region and is coupled to the lamp. The low-voltage winding region has a first pin, a second pin and a third pin. Firstly, the second winding is wound on the first pin and then wound on the low-voltage winding region for M turns. Next, the second winding is drawn out from the low-voltage winding region, then wound on the second pin, and then drawn back to be wound on the low-voltage winding region for N turns again. Afterwards, the second winding is drawn out again and wound on the third pin, where each of M and N is a nature number. In addition, the third pin is coupled to the detecting unit.

### BACKGROUND OF THE INVENTION

1. Field of the Invention

The present invention relates to a transformer; and more particularly, to a transformer suitable for a backlight apparatus.

2. Description of the Prior Art

In recent years, along with the gradually enlarged size of the liquid crystal display panel, the backlight apparatus comprising a plurality of Cold Cathode Fluorescent Lamps (CCFL) is widely utilized to provide the high quality light source needed in the liquid crystal display panel. Because each lamp's brightness of the multi-lamp backlight apparatus is related to the current flowing through said lamp, it's the most significant problem for the multi-lamp backlight apparatus to maintain the currents through all lamps equal approximately, and to make sure the light source provided to the liquid crystal display panel has very stable and uniform brightness to prevent the phenomenon of various brightness among the lamps.

In order to solve the above problem, a balancing circuit called Jin balancer and applied for the multi-lamp backlight system has been proposed. FIG. 1 is a multi-lamp backlight system 1 comprising the Jin balancer structure in the prior art. As shown in FIG. 1, the characteristic of the Jin balancer structure is all the low-voltage side coils 100 of the balance transformers 10 are connected in series to form a closed loop, and therefore the current flowing through the closed loop has a constant value.

Then, the balance transformer 10, according to the constant current, generates a lamp current via the high-voltage side coil 102, and the lamp current is outputted to the lamp 12. Taking advantage of this, the Jin balancer structure makes all of the lamp currents in the multi-lamp backlight system 1 equal to each other approximately, and it makes sure the light source provided to the liquid crystal display panel has very stable and uniform brightness.

In practice, although the Jin balancer structure is able to provide very stable and uniform brightness for the multi-lamp backlight system 1, once the circuit of the multi-lamp backlight system 1 has the abnormality (e.g. the circuit is short or open) and if there is not an overall protection mechanism, the lifetime of the multi-lamp backlight system 1 will be decreased, and even the whole multi-lamp backlight system 1 is destroyed and unable to work.

Please refer to FIG. 1 again. In general, the protection mechanism of the Jin balancer structure is to detect a partial voltage Vd of the closed loop formed by the low-voltage side coils 100, and to decide whether to start the protection mechanism or not by determining the value of the partial voltage Vd. However, the shortcoming of the protection mechanism is that the variable quantity of the partial voltage Vd is not obvious enough, and it is easy to make the protection mechanism work improperly.

Therefore, a major aspect of the invention is to provide a transformer and a backlight apparatus using the same to solve the above mentioned problem.

### SUMMARY OF THE INVENTION

An aspect of the present invention is to provide a transformer and a backlight apparatus using the same.

A transformer is provided according to an embodiment of the invention. The transformer is suitable for a backlight apparatus and the backlight apparatus comprises a lamp and a detecting unit.

The transformer comprises a bobbin, a first winding and a second winding. The bobbin has a low-voltage winding region and a high-voltage winding region. The first winding is wound on the high-voltage winding region and coupled to the lamp. The low-voltage winding region has a first pin, a second pin and a third pin.

The second winding is wound on the first pin and then wound on the low-voltage winding region for M turns. Next, the second winding is drawn out from the low-voltage winding region, then wound on the second pin, and then drawn back to be wound on the low-voltage winding region for N turns again. Afterwards, the second winding is drawn out again and wound on the third pin, wherein each of M and N is a nature number. Besides, the third pin is coupled to the detecting unit.

A backlight apparatus comprising said transformer is provided according to another embodiment of the invention.

The backlight apparatus comprises a high voltage power, a first lamp, a second lamp, a first transformer, a second transformer and a detecting unit. Each of the first transformer and the second transformer comprises a bobbin, a first winding and a second winding. The bobbin has a low-voltage winding region and a high-voltage winding region. The low-voltage winding region has a first pin, a second pin and a third pin.

The first winding is wound on the high-voltage winding region. One end of the first winding of the first transformer is coupled to the first lamp, and the other end is coupled to the high voltage power; one end of the first winding of the second transformer is coupled to the second lamp, and the other end is coupled to the high voltage power.

The second winding is wound on the first pin and then wound on the low-voltage winding region for M turns. Next, the second winding is drawn out from the low-voltage winding region, then wound on the second pin, and then drawn back to be wound on the low-voltage winding region for N turns again. Afterwards, the second winding is drawn out again and wound on the third pin, wherein each of M and N is a nature number. Besides, the second windings of the first transformer and the second transformer are connected with each other to form a loop.

The detecting unit is coupled to the third pins of the first transformer and the second transformer. When a voltage value measured by the detecting unit is over or less than a predetermined value, the high voltage power stops providing power to the first lamp and the second lamp.

The advantage and spirit of the invention may be understood by the following recitations together with the appended drawings.

### BRIEF DESCRIPTION OF THE APPENDED DRAWINGS

FIG. 1 is a multi-lamp backlight system comprising the Jin balancer structure in the prior art.

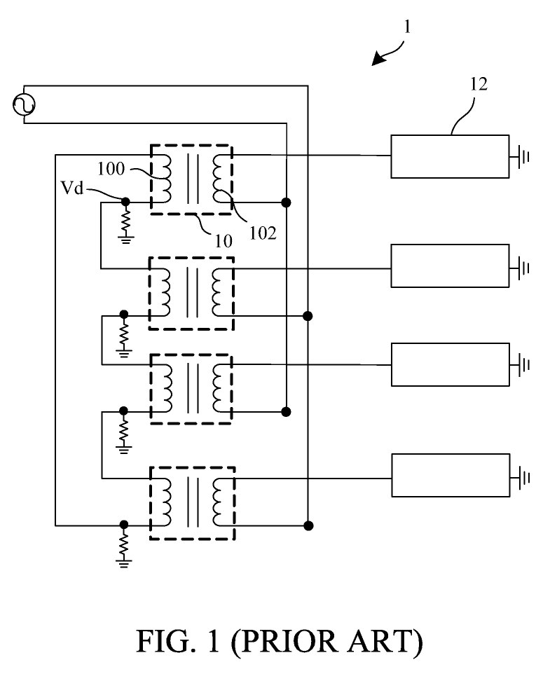

FIG. 2 is an outside view illustrating the bobbin of the transformer.

FIG. 3 is an operating circuit of the transformer according to an embodiment of the invention.

FIG. 4 is a backlight apparatus according to another embodiment of the invention.

FIG. 5 is an operating circuit of the backlight apparatus illustrated in FIG. 4 according to an embodiment of the invention.

### DETAILED DESCRIPTION OF THE INVENTION

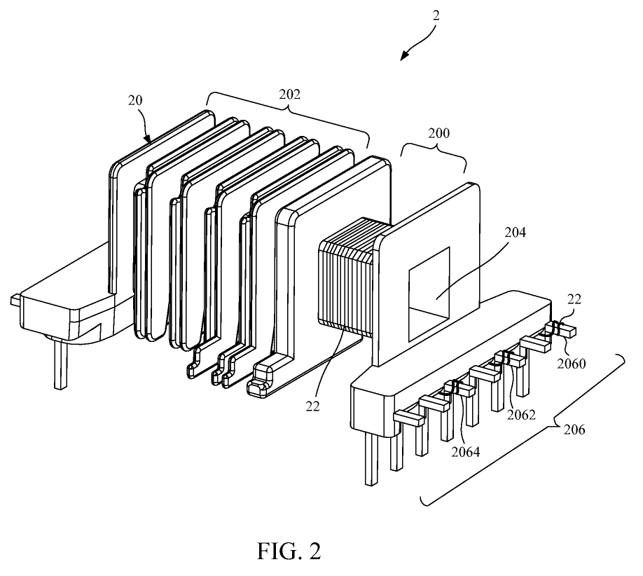

A transformer is provided according to an embodiment of the invention and comprises a bobbin, a magnetic core combination, a first winding and a second winding. Please refer to FIG. 2. FIG. 2 is an outside view illustrating the bobbin 20 of the transformer 2.

As shown in FIG. 2, the bobbin 20 comprises a channel 204 therein and has a high-voltage winding region 202 and a low-voltage winding region 200. The second winding 22 is wound on the low-voltage winding region 200, and the first winding (not shown in FIG. 2) is wound on the high-voltage winding region 202. Besides, the low-voltage winding region 200 has a plurality of first end pins 206.

Generally speaking, the magnetic core combination may comprise a first magnetic part and a second magnetic part. In practice, the appearances of the first magnetic part and the second magnetic part can present roughly E types. And, each of the first magnetic part and the second magnetic part comprises an insertion part; therefore, the first magnetic part and the second magnetic part can be partially inserted into the channel 204 of the bobbin 20 from the two ends thereof and touch each other, so as to form a closed loop of magnetic line.

The second winding 22 of the transformer 2 in the invention can be used for detecting the voltage variation of the transformer 2 in operation, and it relates to the winding way of the second winding 22. Detailed descriptions about how to wind the second winding 22 on the low-voltage winding region 200 of the transformer 2 are presented as follows.

Firstly, the second winding 22 is wound on a first pin 2060 of the plural first end pins 206 and then wound on the low-voltage winding region of the transformer 2 for M turns, wherein M is a nature number.

Next, the second winding 22 is drawn out from the low-voltage winding region, then wound on a second pin 2062 of the plural first end pins 206, and then drawn back to be wound on the low-voltage winding region for N turns again, wherein N is also a nature number. Basically, the numbers of M and N may be determined according to practical demands.

Afterwards, the second winding 22 is drawn out again and wound on the third pin 2064 of the plural first end pins 206 to finish the winding of the second winding 22. Please note that the number of the first end pins 206 is determined according to practical demands and is not limited to the quantity in FIG. 2. For example, the first end pins 206 may only comprise the first pin 2060, the second pin 2062 and the third pin 2064.

From the foregoing, it is known that the second winding 22 is divided into M-turn second winding and N-turn second winding. Besides, the M-turn second winding and the N-turn second winding share the third pin 2064. In an embodiment, the N-turn second winding is wound overlapped on the M-turn second winding.

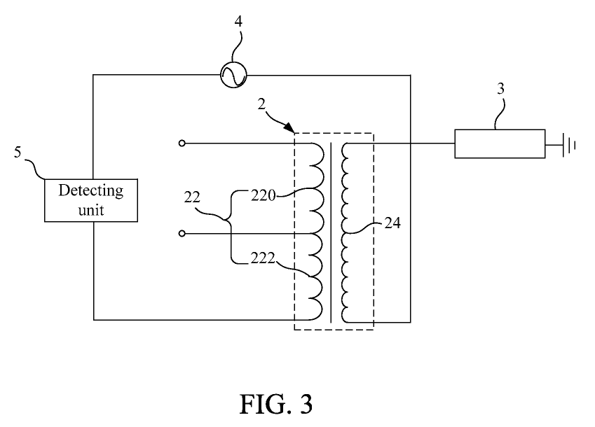

Please refer to FIG. 3. FIG. 3 is an operating circuit of the transformer 2 according to an embodiment of the invention. As shown in FIG. 3, the first winding 24 of the transformer 2 is connected electrically to a lamp 3. In practice, the lamp 3 can be a cold cathode fluorescent lamp. Besides, a high voltage power 4 is connected electrically to the first winding 24 of the transformer 2 and a detecting unit 5 respectively.

As shown in FIG. 3, the M-turn second winding 220 and the N-turn second winding 222 share a pin, and the N-turn second winding 222 is coupled to the detecting unit 5. Thus, the voltage variation of the transformer 2 in operation can be detected by the N-turn second winding 222. The detecting mechanism of the N-turn second winding 222 is described in detail as follows.

When the operating circuit of the FIG. 3 has abnormality (e.g. the cold cathode fluorescent lamp is at an open condition or a short condition), the first winding 24 of the transformer 2 has voltage variation, and so as to make the second winding 22 also has voltage variation. It will cause the variation of the magnetic line's number in the magnetic core combination due to the voltage variation. Therefore, the magnetic flux of the N-turn second winding 222 also changes, so as to change the electromotive force of the N-turn second winding 222 and generate an induced current to flow to the detecting unit 5.

Afterwards, the detecting unit 5 generates a detecting voltage according to the induced current. When the detecting voltage of the detecting unit 5 is over or less than a predetermined value, the high voltage power 4 is controlled to stop providing power to the lamp 3, so as to achieve the function of protection. Because the electromotive force variation of the N-turn second winding 222 is quite huge, it has outstanding sensitivity for detecting the voltage variation of the transformer 2, and it is also relatively stable to protect the circuit.

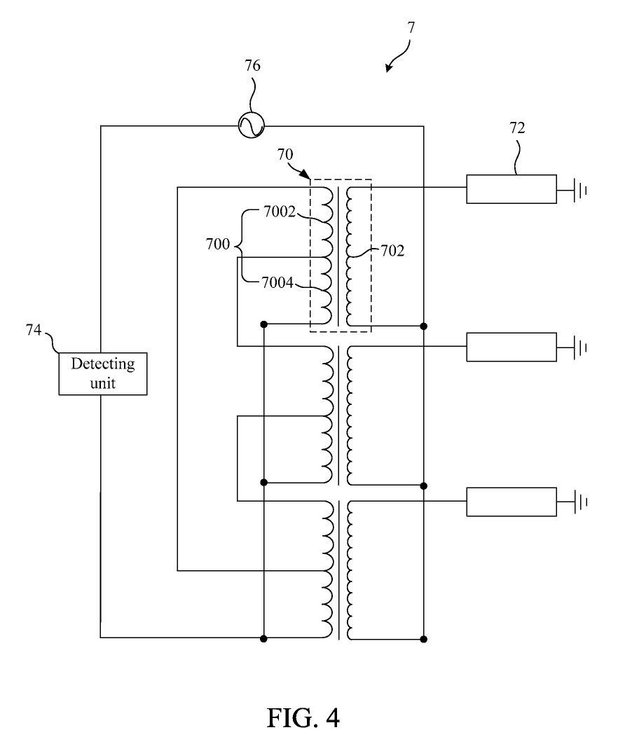

Please refer to FIG. 4. FIG. 4 is a backlight apparatus 7 according to another embodiment of the invention.

The backlight apparatus 7 comprises a high voltage power 76, a detecting unit 74, a plurality of lamps 72 and a plurality of transformers 70. Each transformer comprises a bobbin, a magnetic core combination, a first winding 702 and a second winding 700. The bobbin comprises a channel, and has a low-voltage winding region and a high-voltage winding region thereon. Besides, the low-voltage winding region comprises a plurality of first end pins. Generally speaking, the magnetic core combination comprises a first magnetic part and a second magnetic part. Both the first magnetic part and the second magnetic part are partially inserted into the channel of the bobbin from the two ends thereof and touch each other, so as to form a closed loop of magnetic line.

The second winding 700 is wound on the low-voltage winding region. In addition, the second windings 700 of the transformers 70 are connected in series to form a loop. The first winding 702 is wound on the high-voltage winding region, wherein one end of each first winding 702 is coupled to one corresponding lamp 72, and the other end is coupled to the high voltage power 76.

Since the second windings 700 of the transformers 70 are connected with each other to form a loop, the currents flowing through all the second windings 700 should have the same value. Hereby, the current induced by the first windings 702 wound on the high-voltage winding regions of the bobbins should be the same, so as to make the currents applied to all the lamps 72 of the backlight apparatus 7 are all the same, and it makes sure all the lamps 72 can maintain very stable and uniform brightness.

The winding way of the second winding 700 is aforementioned and will not be further described here. Please note that the second winding 700 can be divided into the M-turn second winding 7002 and the N-turn second winding 7004. The M-turn second winding 7002 and the N-turn second winding 7004 share a pin. The detecting unit 74 is coupled to the shared pin of the M-turn second winding 7002 and the N-turn second winding 7004 of each transformer 70. In an embodiment, the N-turn second winding 7004 can be wound overlapped on the M-turn second winding 7002. Hereby, the voltage variation of each transformer 70 in operation can be detected by the N-turn second winding 7004 thereof. The detecting mechanism of the invention will be described in detail as follows.

When the backlight apparatus 7 in FIG. 4 is abnormal, for example, one cold cathode fluorescent lamp is at an open condition or a short condition, the first winding 702 of the transformer 70 corresponding to the lamp has a voltage variation, and so as to make the second winding 700 also have a voltage variation. It will cause the variation of the magnetic line's number in the magnetic core combination due to the voltage variation. Therefore, the magnetic flux of the N-turn second winding 7004 also changes, so as to change the electromotive force of the N-turn second winding 7004 and generate an induced current to flow to the detecting unit 74.

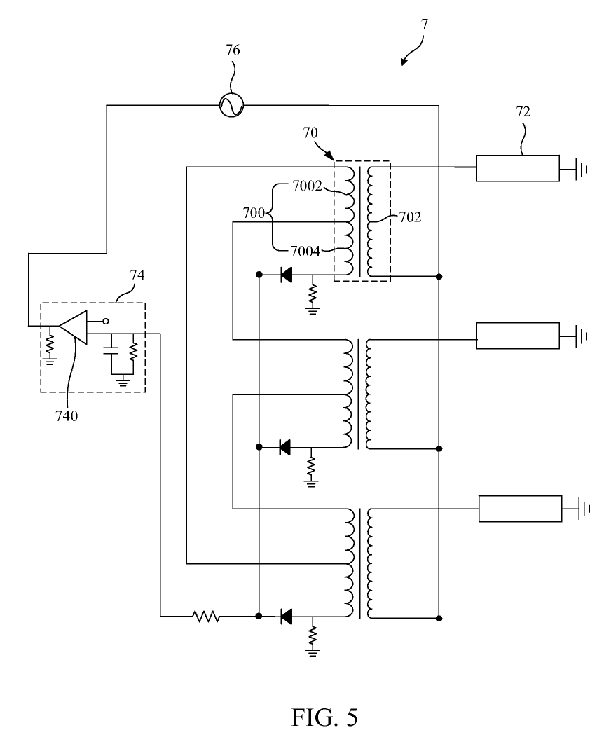

Please refer to FIG. 5. FIG. 5 is an operating circuit of the backlight apparatus 7 illustrated in FIG. 4 according to an embodiment of the invention.

As shown in FIG. 5, the detecting unit 74 may comprise a comparator 740. The comparator 740 is used for comparing the induced voltage generated from the N-turn second winding 7004 with a reference voltage so as to generate a detecting voltage. When the detecting voltage measured by the detecting unit 74 is over or less than a predetermined value, the high voltage power 76 is controlled to stop providing power to each lamp 72 so as to achieve the function of protection. Because the electromotive force variation of the N-turn second winding 7004 is quite huge, it is stable relatively for being applied to protect the circuit.

To sum up, a partial low-voltage winding of the transformer according to the invention can be taken as an induction coil. When the transformer is applied to a backlight apparatus, the induction coil can generate an induced electromotive force according to the variation of the magnetic flux to detect the abnormality of the backlight apparatus. Because the variation of the electromotive force is quite huge, the transformer according to the invention is very suitable for integrating with the protection circuit of the backlight apparatus, which provides a superior and stable sensitivity.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A transformer for a backlight apparatus including a lamp and a detecting unit, the transformer comprising:
a bobbin having a low-voltage winding region and a high-voltage winding region, the low-voltage winding region having a first pin, a second pin and a third pin;
a first winding, the first winding being wound on the high-voltage winding region and being coupled to the lamp; and
a second winding, the second winding being wound on the first pin and then wound on the low-voltage winding region for M turns; next, the second winding being drawn out from the low-voltage winding region, then wound on the second pin, and then drawn back to be wound on the low-voltage winding region for N turns again; afterwards, the second winding being drawn out again and wound on the third pin, wherein each of M and N is a nature number, the third pin being coupled to the detecting unit.

2. The transformer of claim 1, wherein the N-turns second winding is wound on the M-turns second winding.

3. A backlight apparatus comprising:
a high voltage power;
a first lamp;
a second lamp;
a first transformer; and
a second transformer, wherein each of the first transformer and the second transformer comprises:
a bobbin having a low-voltage winding region and a high-voltage winding region, the low-voltage winding region having a first pin, a second pin and a third pin;
a first winding, being wound on the high-voltage winding region, wherein one end of the first winding of the first transformer is coupled to the first lamp, and the other end is coupled to the high voltage power; one end of the first winding of the second transformer is coupled to the second lamp, and the other end is coupled to the high voltage power; and
a second winding, the second winding being wound on the first pin and then wound on the low-voltage winding region for M turns; next, the second winding being drawn out from the low-voltage winding region, then wound on the second pin, and then drawn back to be wound on the low-voltage winding region for N turns again; afterwards, the second winding being drawn out again and wound on the third pin, wherein each of M and N is a nature number, the second windings of the first transformer and the second transformer being connected with each other to form a loop; and
a detecting unit coupled to the third pins of the first transformer and the second transformer, when a voltage value measured by the detecting unit is over or less than a predetermined value, the high voltage power stopping providing power to the first lamp and the second lamp.

4. The backlight apparatus of claim 3, wherein the N-turns second winding is wound on the M-turns second winding.

5. The backlight apparatus of claim 3, wherein both the first lamp and the second lamp are cold cathode fluorescent tubes.
